(19) United States
(12) Patent Application Publication
(10) Pub. No.: US 2010/0218370 A1
(43) Pub. Date: Sep. 2, 2010

(54) Convenient Trash Bag Retention

(76) Inventor: Bo-Yang Lin, Richardsohn, TX (US)

Correspondence Address: Dr. Bo-Yang Lin, 628 Pine Valley, Richardson, TX, 75081, US

(21) Appl. No.: 12/786,410

(22) Filed: May 24, 2010

Related U.S. Application Data
(63) Continuation-in-part of application No. 12/636,740, filed on Dec. 13, 2009.
Application No. 12/636,740 is a continuation-in-part of application No. 11/897,274, filed on Aug. 30, 2007.
Application No. 11/897,274 is a continuation-in-part of application No. 11/949,032, filed on Dec. 22, 2007, now abandoned.
Application No. 11/949,032 is a continuation-in-part of application No. 12/040,871, filed on Mar. 1, 2008, now abandoned.
Application No. 12/040,871 is a continuation-in-part of application No. 12/051,799, filed on Mar. 19, 2008, now abandoned.

(51) Int. Cl. B23P 19/04; B65D 25/14

(52) U.S. Cl. 29/700; 220/495.11

(57) ABSTRACT

A method for easy holding of a trash bag in a trash can: The method comprises of at least one retainer. Each retainer is made of two magnetically coupled pieces which can engage or disengage with each other, with one of the two pieces (the 1^{st} retainer piece) affix to an outside portion of the trash can or integrate into its side(s). Placing the bottom portion of a trash bag inside the trash can with part of the outside portion being captured by the two retainer pieces in the coupled state, a portion (portions) of the trash bag is (are) folded around part(s) of the 1^{st} retainer piece. The folding(s) reduces the force needed to hold the trash bag in place at the coupling portion of the two retainer pieces. The apparatus can be easily operated with one hand, making it very convenient to use.

### CROSS-REFERENCE TO RELATED APPLICATIONS

(Not Applicable)

### STATEMENT REGARDING FEDERALLY SPONSORED RESEARCH/DEVELOPMENT

(Not Applicable)

### BACKGROUND OF THE INVENTION

As is often desired, one needs to attach a sheet to a solid structure so that the sheet, or a portion of it, does not move with respect to the solid structure. An example is the attachment of a trash bag to a trash can.

To keep a trash can clean and for easy trash removal, a trash bag is typically used inside a trash can. Trash bags are notorious for easily falling into a trash can when material is placed inside of them. As a result, the material may fall outside of the trash bag and into the space between the trash bag and the trash can, which makes it difficult to pick the material up. When the material is trash, it also makes the trash can dirty.

Many trash bag and retainer designs have been introduced in the past in order to solve the problem of a trash bag falling into a trash can. Prior arts include many different designs to hold the trash bag in place, for example, tabs inside a trash can (U.S. Pat. No. 3,825,150); an elastic band (U.S. Pat. No. 4,338,979); elastic band with protruding structures (U.S. Pat. No. 7,055,224); handles on a trash bag attached to holders on a trash can (U.S. Pat. No. 4,437,634); a wire frame (U.S. Pat. No. 4,623,111); side bars for supporting handled trash bags (U.S. Pat. No. 5,054,724); interlocked rings (U.S. Pat. No. 5,062,533); clips (U.S. Pat. No. 5,645,186); two handles (U.S. Pat. No. 5,671,861); clamps designed into a trashcan (U.S. Pat. No. 6,484,374). These inventions and others have greatly advanced the art, but are still not convenient enough. The object of the invention is to device a method so that the attachment of a sheet to a solid structure, such as the attachment of a trash bag to a trash can, can be easily made.

### BRIEF SUMMARY OF THE INVENTION

The present invention relates to a method of using a retainer or a set of retainers for the attachment of a sheet or a bag to a solid structure. We call the retainer a “BagMarshall” (see www.BagMarshall.com). An example is the attachment of a trash bag to a trash can.

Each retainer (or BagMarshall) consists of two pieces: One of them is affixed to a trash can (the 1^{st} retainer piece), while the other can engage or disengage with the 1^{st} piece magnetically. When engaged with each other, they fold a portion of the trash bag around the 1 retainer piece and capture a section of the trash bag at the magnetically coupled areas between them. The capturing of the sheet by the two retainer pieces together with the folding(s) prevent the trash bag from slipping into the trash can. The present invention can be operated easily with a single hand, making it very convenient to use.

### BRIEF DESCRIPTION OF THE DRAWINGS

FIG. 1 is the three dimensional and front view of a rectangular 1^{st} retainer piece (10).

FIG. 2 is the three dimensional and front view of a 2^{nd} retainer piece (20).

FIG. 3 is the front view of the 1^{st} and 2^{nd} retainer pieces (10 & 20) magnetically engaged with (coupled to) each other.

FIG. 4 illustrates a retainer piece consisting of two separate pieces affixed to each other.

FIG. 5 has three drawings located at the top, bottom and bottom-right, corresponding to the top, front and side view of a trash can with four of the 1^{st} retainer piece (10) of the holding device affixed.

FIG. 5a is the enlargement of a corner of the trash can in FIG. 5 (the side view) with a 1^{st} retainer piece (10) of the holding device affixed.

FIG. 6 is a three dimensional view of part of the top portion of a trash can with a 1^{st} retainer piece (10) affixed to the outside wall (302).

FIG. 7 is an enlarged front view (view A in FIG. 6) after a portion of the trash can is cut open along the broken line in FIG. 6.

FIGS. 8-11 illustrate the sequence for engaging the 1^{st} (10) and the 2^{nd} (20) retainer pieces for holding a trash bag in place.

FIG. 12 illustrates an alternative embodiment of a 1^{st} retainer piece and its usage for holding a trash bag in place.

FIG. 13 is the three dimensional and front view of the 1^{st} retainer piece (10) in FIG. 12.

FIGS. 14-18 illustrate another alternative embodiment of a 1^{st} retainer piece and its usage for holding a trash bag in place.

FIGS. 19-21 illustrate still another alternative embodiment of the 1^{st} retainer piece and its usage for holding a trash bag in place.

FIGS. 22-24 illustrate an alternative embodiment of the 1^{st} and 2^{nd} retainer pieces and their usage for holding a trash bag in place.

FIGS. 25-28 illustrate a generic embodiment of a 1^{st} and 2^{nd} retainer pieces and their usage for holding a trash bag in place.

FIGS. 29a-29c illustrate the integration of a rectangular 1^{st} retainer piece into a trash can rim and its usage for holding a trash bag in place.

FIGS. 30a-30c illustrate the integration of an n-shaped 1^{st} retainer piece into a trash can rim and its usage for holding a trash bag in place.

### DETAILED DESCRIPTION OF THE INVENTION

As is often desired, one needs to attach a sheet to a solid structure so that the sheet, or a portion of it, does not move with respect to the solid structure. An example is the attachment of a trash bag to a trash can.

As is a common knowledge, a trash can is a container having an open end usually facing upward. It may have a lid to cover up the opening. A trash bag is usually a plastic liner with an opening. Typically the body of a trash bag is placed inside a trash can with the top portion of the trash bag extending beyond the trash can opening to provide a barrier between the trash can wall/bottom and items placed inside.

This invention relates to a new method of attaching a trash bag to a trash can, comprising of: providing at least one retainer consisting of two pieces and the two pieces of the retainer are magnetically coupled to each other; affixing one of the two pieces (the 1^{st} retainer piece) to the outside wall of a trash can; placing the body of a opened trash bag into the trash can with the top portion of the trash bag extending beyond the trash can top; folding outwardly down this portion of the trash bag along the trash can wall beyond the 1^{st} retainer piece by a sufficient length; “folding around” part of the trash bag with respect to the 1^{st} retainer piece by engaging the 2^{nd} retainer piece magnetically with the 1^{st} piece and capturing a portion of the trash bag at their magnetically coupled areas; hence attaching the trash bag to the trash can.

Several elements of the above statements need clarification: a) the method to affix a retainer piece to the outside wall of a trash can is well known to one skilled in the art. It is accomplished by standard means, such as the usage of a double sided tape, a type of glue, a mechanical method; b) the wall of a trash can includes the rim of a trash can. From here on, unless specifically stated otherwise, when a trash can wall is mentioned, it includes the rim of the trash can wall; and c) “engaging the 2^{nd} retainer piece magnetically with the 1^{st} piece” is the direct magnetic coupling between the two retainer pieces and does not involve a third piece, such as a magnet which couples magnetically to the 1^{st} and the 2^{nd} retainer pieces separately.

To help illustrate the present embodiments, many drawings are introduced below. These drawings are for purposes of illustrating the preferred embodiments of the present invention only, not to limit the present invention. There are no dimensional specifications in these drawings so that dimensions may be altered to fit with specific applications.

### A: The 1^{st} Examples of Two Magnetically Coupled Retainer Pieces

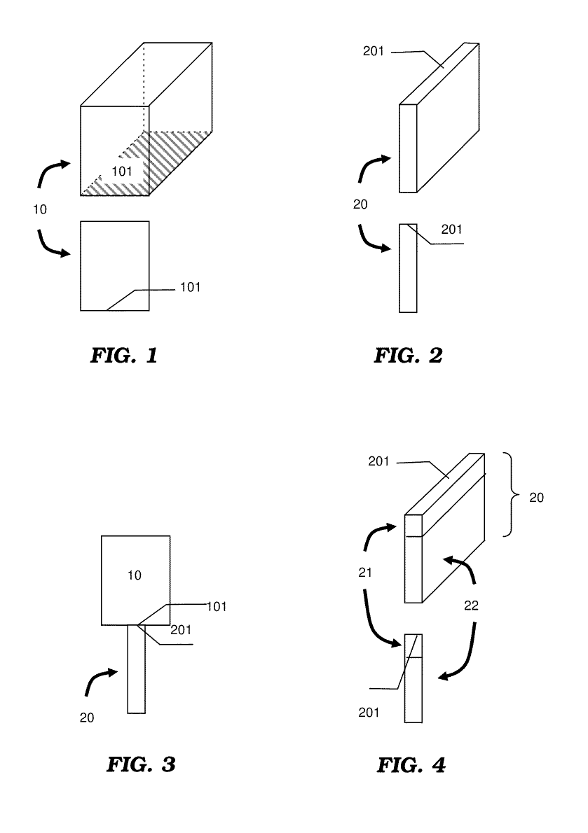

FIGS. 1 & 2 are three dimensional and front view of an exemplary 1^{st} (10) and 2^{nd} (20) piece of a retainer. The 1^{st} retainer piece (10) is rectangular and its bottom surface (101) couples to the top surface (201) of the 2^{nd} retainer piece (20) magnetically. FIG. 3 shows the engagement of the 1^{st} (10) and 2^{nd} (20) retainer pieces of. They are held together by the magnetic force between them.

The magnetic coupling between two pieces, such as piece 10 and 20 of FIGS. 1 & 2, is a common knowledge. It is achieved by known methods such as having one piece being a magnet and the second piece being another magnet or a magnetic part. The magnetic poles need to have correct orientation(s) so as to facilitate the coupling of the two retainer pieces. For example, when a magnet and a piece of magnetic material are used, one of the magnet poles should be perpendicular to their coupling surfaces. When two magnets are used for the coupling, the south pole of a one of the magnets should face the north pole of the other.

Certainly, the magnets or magnetic piece can consist of a magnet or magnetic piece affix to a separate piece such as shown in FIG. 4 where a magnet piece (21) is affixed to a separate piece (22) which can be magnetic or non-magnetic. To couple piece 20 of FIG. 4 to a magnetic piece 10 of FIG. 1, the top surface (201) of piece 21 needs to be the north or the south pole of the magnet. The method to affix one piece of a material to the other, e.g., piece 21 to piece 22 in FIG. 4, is well known to one skilled in the art. It is accomplished by standard means, such as the usage of a double sided tape, a type of glue, a mechanical method.

### B: Holding of a Trash Bag Using the 1^{st} Examples of Two Magnetically Coupled Retainer Pieces

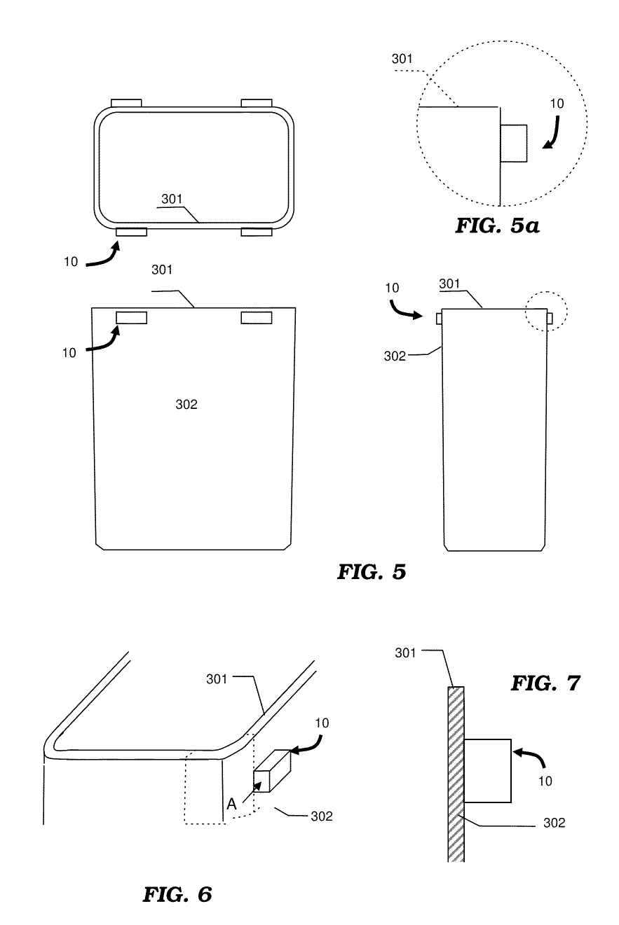

FIG. 5 consists of three separate drawings located at the top, bottom and bottom-right, corresponding to the top, front and side view of a trash can with four of the 1^{st} retainer pieces (10 of FIG. 1) affixed to its outside wall. 301 and 302 are the top and side surfaces of the trash can.

FIG. 5a is the enlargement of a corner of the trash can in FIG. 5 with a 1^{st} retainer piece (10 of FIG. 1) of the holding device affix to the outside wall of the trash can.

FIG. 6 is a three dimensional view of part of the top portion of a trash can with a 1^{st} retainer piece (10 of FIG. 1) affix to the outside of the trash can wall (302).

FIG. 7 is an enlarged view (view A in FIG. 6) after a portion of the trash can is cut open along the broken line in FIG. 6, showing the cross section of part of the trash can wall (302) together with the head on view of piece10.

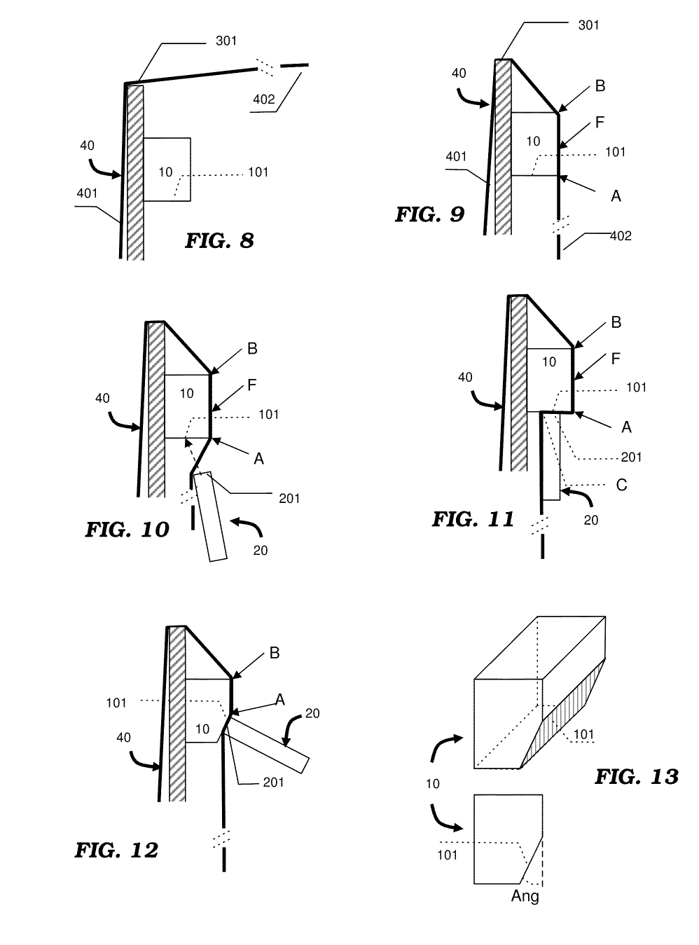

As shown in FIG. 8-11, to hold a trash bag, the body (401) of an opened trash bag (40) needs to be placed in the trash can and the top portion of the trash bag (402) extends beyond the trash can top (301) as shown in FIG. 8. The trash bag outside of the trash can is then folded down covering the 1^{st} retainer piece 10 and extents beyond it by a sufficient length (FIG. 9), so that after the engagement of the retainer pieces 10 and 20, the end of the trash bag extents beyond the coupling portion of the two pieces (101 and 201) as shown in FIG. 11. Fold part of the trash bag around a portion of the 1^{st} retainer piece (10) and sandwich part of the trash bag between 101 and 201 by bringing the top of piece 20 (201) into contact and couples magnetically with the bottom of piece 10 (101) as shown in FIGS. 10 and 11. The folding of a part of the trash bag around a portion of the 1^{st} retainer piece together with the magnetic force between the retainer pieces 10 and 20 acting upon the sandwiched portion of the trash bag prevent the said trash bag from falling into the trash can.

The strength of magnetic force between the two retainer pieces (10 and 20) should be such that it, together with the folding(s), holds the trash bag in place while allowing for easy separation of the two pieces when needed. The folding of a part of the trash bag around a portion of the 1^{st} retainer piece when engaging the two retainer pieces reduces the magnetic force needed to hold the trash bag in place. Without the folding, the strength of the magnetic force needed to hold a trash bag, which is known to be slippery, is so large that the separation of the magnetic pair becomes inconvenient if not impractical. Notice, the trash bag folding is not the existing folding at the trash can rim when one folds over a portion of a trash bag along the outside wall of a trash can as shown by the folding around 301 in FIG. 9, since this folding is not from the engagement of the two retainer pieces.

A key element of this invention is “the folding of a part of the trash bag around a portion of the 1^{st} retainer piece”, or simply “folding around (or fold around)”, which is defined as the bending of a portion of the trash bag which results in that portion of the trash bag wrapping around part of the 1^{st} retainer piece (e.g., corner A of piece 10 in FIGS. 10 and 11). Put it in another way, before the bending occurs, as viewed from the future bending location (location A of the trash bag in FIG. 9), facing along the free end of the trash bag (facing downward in FIG. 9), both of the following elements are on the same side of the trash bag: 1) the future bending direction of the trash bag and 2) the part of the 1^{st} retainer piece where the future bending is to wrap around (corner A of piece 10 in FIGS. 9-11). Both of these elements are to the right side of the trash bag before the bending. Not all trash bag binding due to the engagement of the two retainer pieces needs to wrap around a portion of the 1^{st} retainer piece as will be discussed later.

In FIGS. 10 and 11, “folding around” only occurs at location A, and the “fold around angle” is 90 degrees. The “fold around angle” is defined as the summation of all the bending angles of the trash bag, due to the engagement of the two retainer pieces, where the bending results in a portion of the trash bag “folding around” part of the 1^{st} retainer piece. The “total folding angle”, on the other hand, is the summation of all the bending angles of the trash bag due to the engagement of the two retainer pieces. Both the “fold around angle” and the “total folding angle” only include angles between the portion of the trash bag not changed by the engagement of the two retainer pieces, such as section F of the trash bag in FIGS. 9-11, and the portion of the trash bag caught between the magnetic coupling areas of the two retainer pieces, such as areas 101 and 201 of pieces 10 and 20 in FIG. 11. When more than one pair of magnetically coupled areas is involved, the “magnetic coupling areas of the two retainer pieces” are the pair of coupling areas most distant from the portion of the trash bag not changed by the engagement of the two retainer pieces. Naturally, the “total folding angle” is at least as large as the “fold around angle”.

Notice, the bending at location B in FIGS. 9-11 does “fold around” part of the 1st retainer piece but does not count as part of the “fold around angle” or the “total folding angle”, since it does not change due to the engagement of the two retainer pieces. The bending at location C in FIG. 11 is formed due to the engagement of the two retainer pieces but does not count as part of the “fold around angle” or the “total folding angle” neither, since it is outside of the region between the portion of the trash bag not changed by the engagement of the two retainer pieces (section F) and the portion of the trash bag caught between the magnetic coupling areas of the two retainer pieces (areas 101 and 201 of pieces 10 and 20). The bending at location C does not wrap around a portion of the 1^{st} retainer piece.

In general, the larger the “fold around angle”, the smaller the magnetic force is needed to hold the trash bag in place. Consequently, the “fold around angle” is a key element of this invention.

### C. Other Exemplary Designs of Retainer Pieces and the Holding of a Trash Bag

As is obvious to one skilled in the art, the exact shape of the two holding pieces can be varied and the number of variation is limitless. FIG. 12 shows an embodiment where the “fold around angle” is less than 90 degrees. FIG. 13 is an enlarged three dimensional and front view of the 1^{st} retainer piece (10) in FIG. 12. This piece is a rectangle with a cut (surface 101) parallel to its edges as shown. The cut angle “Ang” in FIG. 13 is less than 90 degrees. Surface 101 of the 1^{st} retainer piece (10) couples magnetically to the top surface (201) of the 2^{nd} retainer piece (20) in FIG. 2. This is accomplished by, for example, the 1^{st} retainer piece (10) being made of a magnetic material and the 2^{nd} retainer piece (20) being a magnet with one of its magnetic poles at its top surface (201). The “fold around angle” is the bending angle at locations A of FIG. 12, which is equal to the cut angle “Ang” in FIG. 13, and is less than 90 degrees.

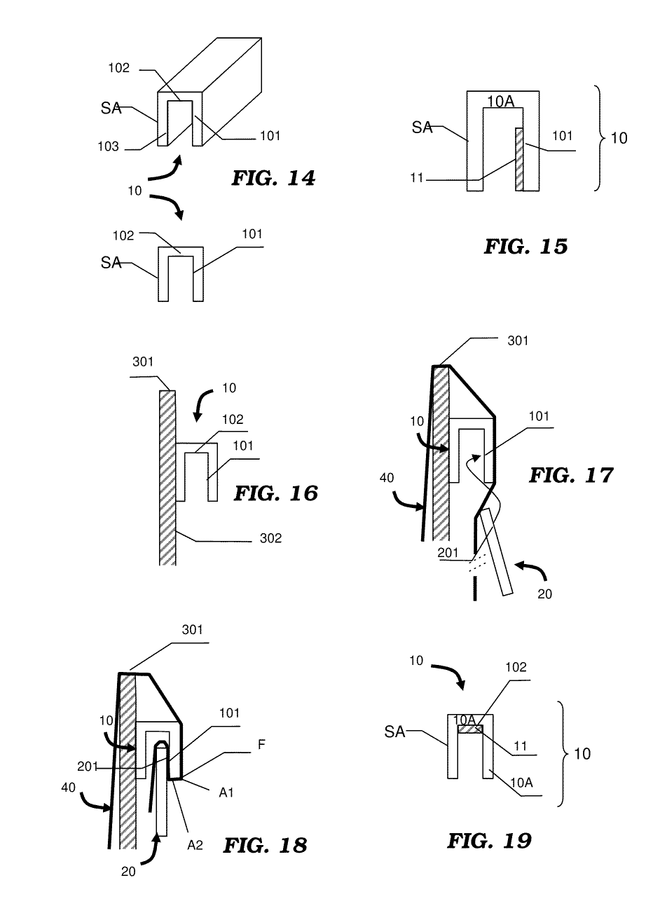

The “fold around angle” can certainly be greater than 90 degrees. As an example, the 1^{st} retainer piece is n-shaped as shown in FIG. 14 and the 2^{nd} retainer piece remains the same as shown in FIG. 2. The magnetic coupling between the two pieces is at the inside vertical wall (101) of the n-piece as shown in FIG. 14. This can be achieved by, for example, 1) having the 2^{nd} retainer piece (FIG. 2) being magnetic; 2) having the 1^{st} retainer piece (10) being a combination of a magnet piece (11) affixed to side 101 of a non-magnetic n-piece (10A) as shown in FIG. 15. The poles of the magnetic piece 11 should be at the left and right surfaces of piece 11. In subsequent figures (FIGS. 16-18), the magnet piece 11 will not be shown. It is understood that side 101 of piece 10 is where the magnetic coupling between the two retainer (10 and 20) pieces occurs.

Side SA of the 1^{st} retainer piece 10 of FIG. 15 is affixed to the outside of a trash can wall (302) as shown in FIG. 16, where 301 is the top of the trash can wall. Engage the 2^{nd} retainer piece (20) to the 1^{st} retainer piece (10) at their magnetically coupled areas (areas 101 and 201) as shown in FIGS. 17 and 18. This engagement folds a portion of the trash bag around the 1^{st} retainer piece and sandwiches a section of the trash bag between the magnetic coupling areas of the two retainer pieces. The folding of the trash bag around the 1^{st} retainer piece 10 is at locations A1 and A2. In this example, the “fold around angle” equals the “total folding angle” and is 180 degrees.

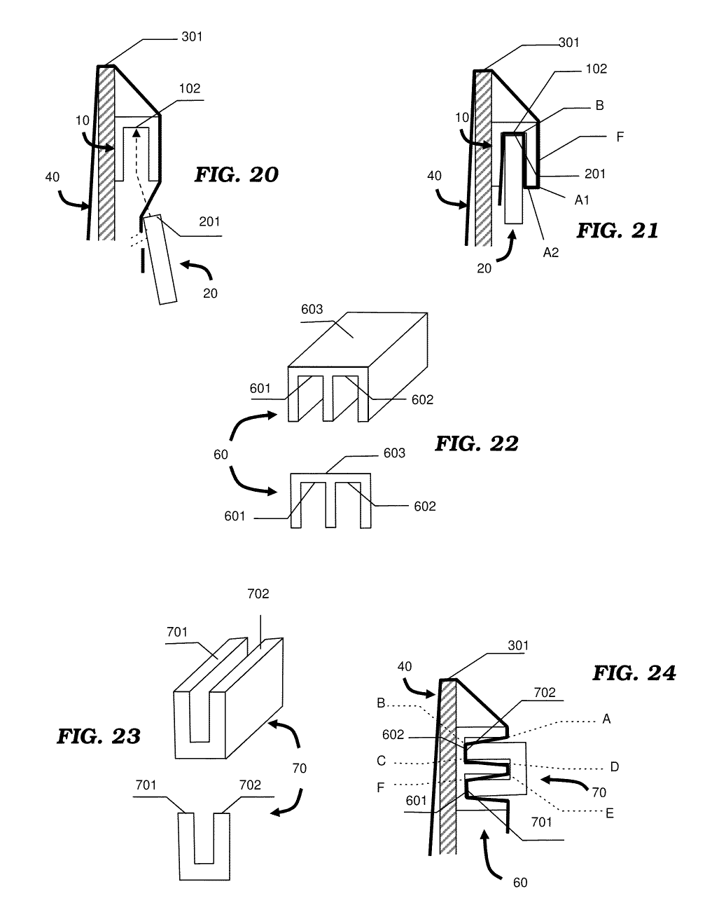

In still another embodiment with a “fold around angle” of greater than 90 degrees, the magnetic coupling of the n-shaped 1^{st} retainer piece and the 2^{nd} retainer piece is at the upper inside surface (102) of the n-piece as shown in FIG. 14. This can be achieved by, for example, 1) having the 2^{nd} retainer piece (FIG. 2) being magnetic; 2) having the 1^{st} retainer piece (10) being a combination of a magnet piece (11) affixed to side 102 of a non-magnetic n-piece (10A) as shown in FIG. 19. The poles of the magnetic piece 11 should be at the up and down surfaces of piece 11. In subsequent figures (FIGS. 20-21), the magnet piece 11 will not be shown. It is understood that side 102 of piece 10 is where the magnetic coupling between the two magnetic pieces occurs.

Side SA of the 1^{st} retainer piece 10 of FIG. 14 is affixed to the outside of a trash can wall (302) as shown in FIG. 16 where 301 is the top of the trash can wall. Place a trash bag inside the trash can etc as discussed around FIGS. 8 and 9. Engage the 2^{nd} retainer piece (20) to the 1^{st} retainer piece (10) at their magnetically coupled areas (areas 102 and 201) as shown in FIGS. 20 and 21. This engagement folds a portion of the trash bag and catches a section of the trash bag between the magnetic coupling areas of the two retainer pieces (102 and 201 of pieces 10 and 20 respectively).

In this example, the folding of the trash bag around the 1^{st} retainer piece 10 is at locations A1 and A2 (FIG. 21). The “fold around angle” is close to but not necessarily 180 degrees since the folding at location A1 is 90 degrees and at location A2 is close to, but is not necessarily, 90 degrees. The bending of the trash bag at location B (FIG. 21) does not “fold around” part of the 1^{st} retainer piece. Consequently, this bending does not count as part of the “fold around angle” but does count as part of the “total folding angle”. The bending at location B is close to, but is not necessarily, 90 degrees. The “total folding angle” is the summation of bending at locations A1, A2, and B. This “total folding angle” is close to, but is not necessarily, 270 degrees.

In general, the extent of the “fold around angle” and the “total folding angle” should not be limited. As shown in FIGS. 22 and 23 which are still other exemplary variations of the present embodiment. The 1^{st} retainer piece 60 in FIG. 22 has a magnet (not shown) affixed to each of its top undersides (601, 602), i.e., it essentially consists of two units of piece 10 in FIG. 19. The corresponding 2^{nd} retainer piece 70 (FIG. 23), made of, for example, a magnetic material, has two ridges (701 and 702) and can couple magnetically to the two top undersides of piece 60 (601, 602 of FIG. 22). FIG. 24 shows that piece 60 is affixed to the outside wall of a trash can with 301 being its top. The 2^{nd} retainer piece 70 is engaged to the 1^{st} retainer piece 60 at the two magnetic coupling areas of 701/601 and 702/602 capturing two sections of the trash bag. This engagement folds a portion of the trash bag 40 which helps hold the trash bag in place.

In this example, the “fold around angle” is the summation of bending at locations A, D and E. The “fold around angle” is close to 270 degrees. The “total folding angle” is the summation of the “fold around angle” and the bending at locations B, C and F. The “total folding angle” is close to 540 degrees. The “fold around angle” and “total folding angle” increase as more of the n-shaped units (FIG. 19) are joint together similar to what is shown in FIG. 22, where the piece consists of two of the n-shaped units. The number of the corresponding coupling ridges needs to increase accordingly, similar to what is shown in FIG. 23, where the piece has two coupling ridges.

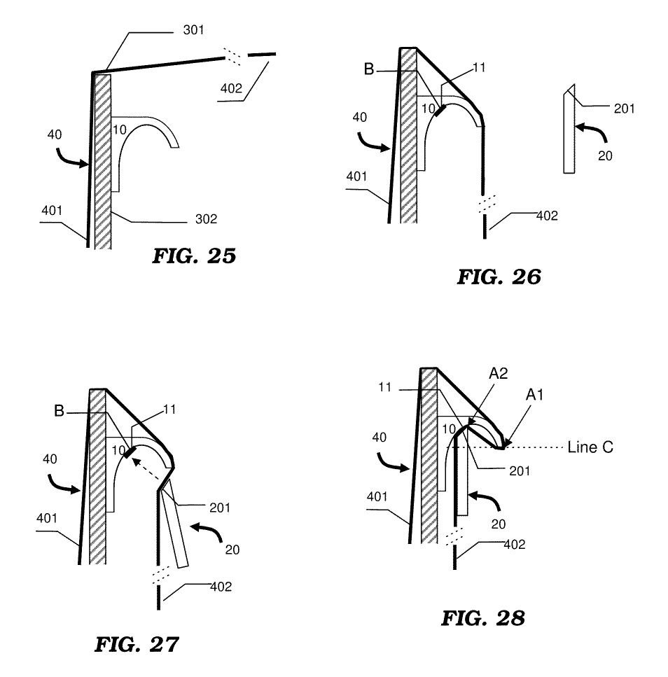

Many of the above examples of the 1^{st} retainer piece (FIGS. 15, 19, 22) can be generalized as a piece with at least one “hollowed structure” as shown in FIG. 25. Here, a “hollowed structure” means a structure with an angled or curved portion, not a just straight piece. This “hollowed structure” has one underside which is the concaved side for a curved piece (Piece 10 of FIG. 25) and is the side having an angle of less than 180 degrees for an angled piece (e.g., the side where the portions 101-103 are in FIG. 14). The “hollowed structure” needs to have at least one opening for accessing its underside for the magnetic coupling between this 1^{st} retainer piece (10) and a 2^{nd} retainer piece. When used for attaching a trash bag to a trash can with the two retainer pieces engaged with each other magnetically, this “hollowed structure” allows for part of the trash bag to “fold around” a portion of the 1^{st} retainer piece, e.g., as shown in FIG. 28.

The exact form of this “hollowed structure” has infinite variations. For example, the “hollowed structure”, which is the 1^{st} retainer piece, can be made of a non-magnetic material (Piece 10 of FIGS. 25, 26). Affix a magnet (11) to location B of piece 10 (FIG. 26) and the 2^{nd} retainer piece can be made of a magnetic material and is shaped in such a way (e.g., piece 20 of FIG. 26) that its top (201) couples easily with magnet 11.

To use such a hollowed structure for the attachment of a trash bag to a trash can, one needs to, for example (FIGS. 25-28), affixing piece 10 to the outside wall (302) of a trash can (FIG. 25); placing the body (401) of an opened trash bag (40) in the trash can with the top portion of the trash bag (402) extending beyond the trash can top (301) as shown in FIG. 25; folding down the top portion of the trash bag to cover the 1^{st} retainer piece 10 and extent beyond it by a sufficient length (FIG. 26), so that after the engagement of pieces 10 and 20, the end of the trash bag (402) extents beyond the coupling portion of the two retainer pieces (11 and 201) as shown in FIG. 28; folding part of the trash bag around a portion of the 1^{st} retainer piece (10) and sandwiching part of the trash bag between 11 and 201 by bringing the top of piece 20 (201) into contact and engage magnetically with piece 11 as shown in FIGS. 27 and 28.

Location A1 on piece 10 (FIG. 28) is the 1^{st} location where the trash bag “folds around” part of this 1st retainer piece due to the engagement of the two retainer pieces. A2 on piece 20 (FIG. 28) is the 1^{st} location (starting from location A1 and follow the trash bag in the direction for reaching the trash bag top) where the trash bag “folds around” part of this 2^{nd} retainer piece (20). Here, the “fold around” of the 2^{nd} retainer piece is defined as the bending of a portion of the trash bag which results in that portion of the trash bag wrapping around part of the 2^{nd} retainer piece (location A2 of piece 20 in FIG. 28).

As shown in FIG. 28, Line C is the tangential line to the location on piece 10 where the trash bag has a 90 degree “fold around angle” with respect to piece 10. As is obvious (FIG. 28), the “fold around angle” to the 1^{st} retainer piece 10 is greater than 90 degrees if A2 is above Line C and less than 90 degrees if A2 is below Line C and is 90 degrees if A2 is on Line C.

D. Integration into a Trash can

As is obvious to one skilled in the art, the 1^{st} retainer piece, which is the piece affixed to a trash can, can be integrate into the trash can, i.e., the 1^{st} retainer piece can be produced as an integral part of the trash can manufacture process not a separate piece affixed to the trash can.

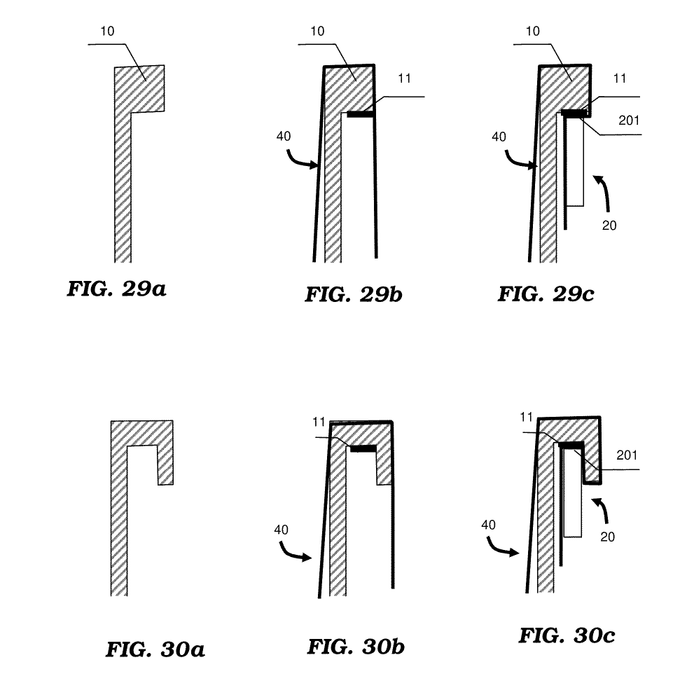

As an example, the rectangular piece in FIG. 1 (piece 10) is integrated into the trash can rim so that the cross section of the trash can top (e.g., the top of the shaded area in FIG. 16) is not straight, but protrudes outwards as shown by the top of the shaded area in FIG. 29a. As shown in FIG. 29b, affix a magnet (11) to the underside of the protruding rectangle and arrange the trash bag (40) the same way as shown in and discussed around FIGS. 8 and 9. The magnet piece 11 in FIG. 29b has its magnetic poles at the upper and lower surfaces. Fold part of the trash bag around the lower-right corner of piece 10 and sandwich part of the trash bag between piece 11 and the top (201) of a magnetic piece 20 by bringing the top of piece 20 into contact and couples magnetically with the piece 11.

In this example, the “fold around angle” equals to the “total folding angle” and is 90 degrees, which is, not surprisingly, identical to the “fold around angle” and the “total folding angle” in FIG. 11 where the rectangle piece 10 in FIG. 1 is affixed to the side of a trash can, instead of integrated into the trash can rim. The integration, such as that of piece 10 into the rim of a trash can as discussed above, can certainly be done at other trash can locations, such as at the trash can side, as is obvious to one skilled in the art.

Similarly, any 1^{st} retainer piece can be integrated into a trash can, e.g., into the trash can rim or side. For example, the n-piece shown in FIG. 14 can be integrated into the trash can rim so that the cross section of the trash can top (top of the shaded area in FIG. 16) is not straight but is n-shaped as shown by the top of the shaded area in FIG. 30a. As shown in FIG. 30b, affix a magnetic material (11) to the underside of the n-shaped region and arrange the trash bag (40) the same way as shown in and discussed around FIGS. 8 and 9. The magnet piece 11 has its magnetic poles at the upper and lower surfaces. Fold part of the trash bag around part of the n-shaped section and sandwich part of the trash bag between piece 11 and the top (201) of a magnetic piece 20 by bringing the top of piece 20 into contact and couples magnetically with the piece 11.

In this example, the “fold around angle” is close to 180 degrees and the “total folding angle” and is close to 270 degrees, which are, not surprisingly, identical to the “fold around angle” and the “total folding angle” in FIG. 21 where the n-shaped piece 10 in FIG. 19 is affixed to the side of a trash can, instead of being integrated into the trash can rim. The integration, such as that of the n-shaped piece 10 into the rim of a trash can as discussed above, can certainly be done at other trash can locations, such as at the trash can side, as is obvious to one skilled in the art.

### E. Closing

Illustrations above provide exemplary embodiments of the present invention. The scope of the present invention is not limited by these illustrations. The number of variations, some of which are shown in this specification, is limitless. These variations may be implemented by one skilled in the art in view of this disclosure.

### REFERENCES CITED

U.S. Patent Documents

| Patent # | Issue Date | Inventor(s) |
|---|---|---|
| 3,825,150 | Jul. 23, 1974 | Taylor |
| 4,338,979 | Jul. 13, 1982 | Dow |
| 4,437,634 | Mar. 20, 1984 | Hambleton |
| 4,623,111 | Nov. 18, 1986 | Prader |
| 5,054,724 | Oct. 8, 1991 | Hutcheson |
| 5,062,533 | Nov. 5, 1991 | Fickes, et al. |
| 5,645,186 | Jul. 8, 1997 | Powers, et al. |
| 5,671,861 | Sep. 30, 1997 | Hall, et al. |
| 6,484,374 | Nov. 26, 2002 | McAllister |
| 7,055,224 | Jun. 6, 2006 | Bathey |

1. A method of attaching a trash bag to a trash can, comprising of: providing at least one retainer consisting of two pieces which are magnetically coupled to each other; affixing one of the two pieces (the 1^{st} retainer piece) to the outside wall of a trash can; placing the body of an opened trash bag into the trash can with the top portion of the trash bag extending beyond the trash can top; folding outwardly down this portion of the trash bag along the trash can wall beyond the 1^{st} retainer piece; “folding around” part of the trash bag with respect to the 1^{st} retainer piece by engaging the 2nd retainer piece magnetically with the 1^{st} piece and capturing a portion of the trash bag at their magnetically coupled areas; hence attaching the trash bag to the trash can.

2. The method as claimed in claim 1 wherein the “folding around” part of the trash bag with respect to the 1^{st} retainer piece by engaging the 2 retainer pieces magnetically has a “fold around angle” of 90 degrees.

3. The method as claimed in claim 1 wherein the “folding around” part of the trash bag with respect to the 1^{st} retainer piece by engaging the 2 retainer pieces magnetically has a “fold around angle” of greater than 90 degrees.

4. The method as claimed in claim 1 wherein the “affixing of the 1^{st} retainer piece to the outside wall of a trash can” is accomplished by integrating the 1^{st} retainer piece into the trash can.

5. The method as claimed in claim 1 wherein the “affixing of the 1^{st} retainer piece to the outside wall of a trash can” is accomplished by integrating the 1^{st} retainer piece into the trash can and the “folding around” part of the trash bag with respect to the 1^{st} retainer piece by engaging the 2 retainer pieces magnetically has a “fold around angle” of 90 degrees.

6. The method as claimed in claim 1 wherein the “affixing of the 1^{st} retainer piece to the outside wall of a trash can” is accomplished by integrating the 1^{st} retainer piece into the trash can and the “folding around” part of the trash bag with respect to the 1^{st} retainer piece by engaging the 2 retainer pieces magnetically has a “fold around angle” of greater than 90 degrees.

7. The method as claimed in claims 1-6 wherein the 1^{st} retainer piece has at least one “hollowed structure”.
